(19) United States
(12) Patent Application Publication
(10) Pub. No.: US 2005/0085577 A1
(43) Pub. Date: Apr. 21, 2005

(54) Oxygen scavenging packaging having improved sensory properties

(76) Inventors: Ta Yen Ching, Houston, TX (US); James Solis, Groves, TX (US); Ronald Abbott, Kingwood, TX (US); William A. Diecks, Houston, TX (US); Darrell Landry, Nederland, TX (US)

Correspondence Address: WILLIAMS, MORGAN & AMERSON, P.C., 10333 RICHMOND, SUITE 1100, HOUSTON, TX, 77042, US

(21) Appl. No.: 10/940,007

(22) Filed: Sep. 13, 2004

Related U.S. Application Data
(60) Provisional application No. 60/501,939, filed on Sep. 11, 2003.

(51) Int. Cl. C09K 3/00; C08K 5/04; B32B 27/08; C08K 3/34

(52) U.S. Cl. 524/394; 524/450; 524/495; 428/474.4; 428/480

(57) ABSTRACT

We disclose a packaging article, defining a package interior and a package exterior, and comprising (i) a first layer, containing an oxygen scavenging polymer the oxygen scavenging polymer comprises (a) an ethylenic backbone or a polyester backbone and (b) at least one cyclic olefinic group; (ii) a second layer, containing a functional barrier polymer; and (iii) a transition metal organic salt in at least one of the first layer or a layer adjacent to the first layer; wherein the second layer is located between the first layer and the package interior. The packaging article can further comprise a functional absorber. Such a packaging article is capable of both scavenging oxygen present in the package interior and inhibiting the migration of off-taste- or off-odor-imparting scavenging byproducts from the first layer to the package interior.

This application claims priority from U.S. patent application Ser. No. 60/501,939, filed on Sep. 11, 2003.

### BACKGROUND OF THE INVENTION

1. Field of the Invention

The present invention relates generally to the fields of oxygen scavenging packaging articles. More particularly, it concerns oxygen scavenging packaging articles imparting improved odor and taste profiles to packaged foods and beverages.

2. Description of Related Art

The use of oxygen scavenging polymers in packaging articles can reduce oxidative damage to packaged materials, such as foods and beverages. Generally, such oxygen scavenging polymers function by irreversibly reacting with oxygen present in the package interior as an artifact of filling the package or entering the package during storage or use. Commonly, the function of the oxygen scavenging polymers is improved by including transition metal organic salts and photoinitiators in proximity to or mixed with the oxygen scavenging polymers.

One shortcoming seen in many packaging articles containing oxygen scavenging polymers is that, during the course of oxygen scavenging, scavenging byproducts form. Examples of scavenging byproducts vary, depending on the structure of the oxygen scavenging polymer, the transition metal organic salt, and the like, but can include fragments of the oxygen scavenging polymer, the organic counterion of the transition metal organic salt, or both. Under certain circumstances which will be apparent to the skilled artisan, these fragments can migrate out of the packaging article and into the package interior. Because these fragments are generally small and organic, they can impart off-odors or off-tastes to the package contents, especially foods and beverages, which is less desirable in a commercial application.

Therefore, it would be of benefit to have a packaging article which can both scavenge oxygen and do so while imparting a minimal, or even negligible, off-odor or off-taste to a packaged food or beverage.

### SUMMARY OF THE INVENTION

In one embodiment, the present invention relates to a packaging article, defining a package interior and a package exterior, and comprising:
a first layer, containing an oxygen scavenging polymer;
a second layer, containing a functional barrier polymer; and
a transition metal organic salt in at least one of the first layer or a layer adjacent to the first layer;
wherein the second layer is located between the first layer and the package interior, and the oxygen scavenging polymer comprises (i) an ethylenic backbone or a polyester backbone and (ii) at least one cyclic olefinic group.

Such a packaging article is capable of both scavenging oxygen present in the package interior and inhibiting the migration of off-taste-imparting scavenging byproducts from the first layer to the package interior.

### BRIEF DESCRIPTION OF THE DRAWINGS

The following drawings form part of the present specification and are included to further demonstrate certain aspects of the present invention. The invention may be better understood by reference to the drawings in combination with the detailed description of specific embodiments presented herein.

FIG. 1 shows a packaging article according to one embodiment of the present invention.

FIG. 2 shows a packaging article according to a second embodiment of the present invention.

FIG. 3 shows a packaging article according to a third embodiment of the present invention.

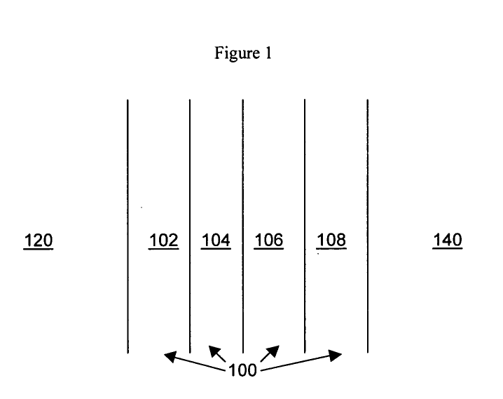

None of FIGS. 1-3 is to scale.

### DESCRIPTION OF ILLUSTRATIVE EMBODIMENTS

In one embodiment, the present invention relates to a packaging article, defining a package interior and a package exterior. The article can comprise (i) a first layer, containing an oxygen scavenging polymer; (ii) a second layer, containing a functional barrier polymer; (iii) a transition metal organic salt in at least one of the first layer or a layer adjacent to the first layer. The second layer is located between the first layer and the package interior, and the oxygen scavenging polymer comprises (i) an ethylenic backbone or a polyester backbone and (ii) at least one cyclic olefinic group.

As used herein, unless expressly specified to the contrary, the word “or” has the inclusive sense.

The term “adjacent,” as used herein to refer to layers A and B, indicates that at least a portion of layer A is within about 1 mil of a portion of layer B.

The terms “package interior” and “package exterior” are used herein to refer to volumes of space which are defined by the packaging article but do not include the packaging article or any layer thereof.

The packaging article can be any article useful in containing a product in the package interior and which can comprise the first layer, the second layer, the transition metal organic salt, and a functional barrier (if any), and comply with the provided conditions. In some embodiments, the packaging article can also contain a functional absorber. The packaging article can be characterized as having both a surface area (an area generally exposed to either the package interior or the package exterior) and a thickness (a distance between the surface generally exposed to the package interior and the surface generally exposed to the package exterior).

Examples of packaging articles which can be within the scope of the claims include, but are not limited to, cartons, bottles, cans, trays, films, and inserts, among others.

The multilayer structure of the present invention can either form the entire packaging article or a portion of the packaging article. Examples of the latter embodiment include, but are not limited to, a tray comprising the multilayer structure of the present invention covered by a lid which need not comprise the multilayer structure of the present invention, a lid comprising the multilayer structure of the present invention covering a tray which need not comprise the multilayer structure of the present invention, or an insert placed in a packaging article containing another structure, among others which will be apparent to the ordinary skilled artisan having the benefit of the present disclosure.

In one embodiment, the packaging article is a gable-top carton.

The packaging article of the present invention can contain an oxygen sensitive product. In an embodiment, the packaging article of the present invention can contain a beverage or food in the package interior. In an embodiment, the food can be meat, cheese, pasta, or any other solid food. In one embodiment, the beverage can be a juice. In another embodiment the juice can be a fruit juice or a vegetable juice. In another embodiment the juice can be a fruit juice. In one embodiment, the juice can be an orange juice.

As stated above, the packaging article comprises a first layer. The first layer comprises an oxygen scavenging polymer.

An “oxygen scavenging polymer” can be any polymeric organic compound that irreversibly reacts with oxygen. The polymer can be an addition polymer or a condensation polymer. A number of oxygen scavenging polymers are disclosed by Blinka et al., U.S. Pat. No. 6,391,403, and Bansleben et al., PCT Publ. Appln. WO 97/32925, which are hereby incorporated by reference. Other oxygen scavengers include ascorbates, isoascorbates or mixtures thereof with each other or with sulfites, as disclosed by Hofeldt et al., U.S. Pat. Nos. 5,075,362; 5,106,886; 5,204,389; and 5,227,411; transition metals complexed or chelated with an ascorbate, a polycarboxylic or salicylic acid, or a polyamine, as disclosed by Zapata Industries or Aquanatics Corp., PCT Publ. Applns. WO 91/17044; WO 94/09084; and WO 88/06641; reducible, oxygen-reactive organic compounds, such as quinones, photoreducible dyes, or carbonyl compounds, as disclosed by CSIRO, PCT Publ. Appln. WO 94/12590; among others.

Examples of addition oxygen scavenging polymers include, but are not limited to, polymer or copolymer containing either a main chain or pendant cyclic olefinic group, such as a cyclic olefin group having a cyclohexene structure, such as ethylene/methyl acrylate/cyclohexenylmethyl acrylate terpolymer (EMCM), ethylene/vinyl cyclohexene copolymer (EVCH), ethylene/cyclohexenylmethyl acrylate copolymer (ECHA), or cyclohexenylmethyl acrylate homopolymer (CHAA). Examples also include, but are not limited to, polymer or copolymers containing pendant benzylic group, such as ethylene/methyl acrylate/benzylmethyl acrylate terpolymer (EMBZ). Examples also include, but are not limited to, diene polymers such as polyisoprene, polybutadiene, and copolymers thereof, e.g. styrene-butadiene. Also included are polymeric compounds such as polypentenamer, polyoctenamer, and other polymers prepared by olefin metathesis; diene oligomers such as squalene; and polymers or copolymers derived from dicyclopentadiene, norbomadiene, 5-ethylidene-2-norbomene, or other monomers containing more than one carbon-carbon double bond (conjugated or non-conjugated).

Examples of condensation oxygen scavenging polymers include, but are not limited to, condensation polymers such as polyester polymers or copolymers containing carbon-carbon double bonds. In one embodiment, the polyester polymer containing carbon-carbon double bonds is derived from polybutadiene. Examples of these polymers are described in WO 98/12127, which is hereby incorporated by reference. In another embodiment, the polyester contains either a main chain or a pendant cyclic olefinic group, such as a cyclohexene moiety. In one embodiment, the condensation polymer is produced by condensation across the hydroxyl or carboxyl groups of a benzyl-, cycloalkyl- or cycloalkenyl-diol or -dicarboxylic acid, such as 3-cyclohexene-1,1-dimethanol, optionally with an appropriate comonomer, to form a polyether, polyester, polyamide, or other polymer. In another embodiment, the condensation polymer can be produced by condensation across the hydroxyl or carboxyl groups of a cycloalkenyldiol or cycloalkenyl dicarboxylic acid. In yet another embodiment, the condensation polymer can be a polyamide produced from a cycloalkenyl diamine or cycloalkenyl dicarboxylic acid.

In one embodiment, the oxygen scavenging polymer comprises either an ethylenic or a polyester backbone and at least one cyclic olefinic group, either in the main chain or as a pendant group. In one embodiment, the cyclic olefinic group can be a pendant cyclic olefinic group. In a further embodiment, the cyclic olefinic group is a cycloalkenyl group having the structure I: 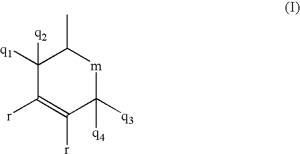
wherein q₁, q₂, q₃, q₄, and r are independently selected from hydrogen, methyl, or ethyl; m is —(CH₂)ₚ—, wherein p is an integer from 0 to 4, inclusive; and, when r is hydrogen, at least one of q₁, q₂, q₃, and q₄ is also hydrogen.

In one embodiment, the oxygen scavenging polymer further comprises a linking group linking the ethylenic backbone to the cyclic olefinic group. The linking group can be selected from:
—O—(CHR″)ₙ—; —(C═O)—O—(CHR″)ₙ—; —NH—(CHR″)ₙ—; —O—(C═O)—(CHR″)ₙ—; —(C═O)—NH—(CHR″)ₙ—; —(C═O)—O—CHOH—CH₂—O—; or —(CH₂)ₙ—;
wherein each R″ is independently hydrogen, methyl, ethyl, propyl, or butyl, and n is an integer from 0 to 4, inclusive. (In other words, when n is 0, the linking group can be null, viz. —(CH₂)₀—). In one particular embodiment, the cyclic olefinic group is a cycloalkenyl group having the structure I. In another particular embodiment, in structure I, p is 1, and q₁, q₂, q₃, q₄, and r are each hydrogen.

In one embodiment, the oxygen scavenging polymer is poly(ethylene/vinyl cyclohexene) (EVCH), ethylene/methyl acrylate/cyclohexenyl methyl acrylate terpolymer (EMCM), poly(cyclohexene methyl methacrylate) (CHMA), or poly(cyclohexene methyl acrylate) (CHAA). These polymers, and others containing cyclic olefinic pendant groups as the primary oxygen-reactive moieties, are believed to generate fewer migratable reaction byproducts. Though not to be bound by theory, we believe that cleavage of a ring upon reaction with oxygen leads to an opened ring (a linear or branched moiety), whereas cleavage of a linear or branched moiety leads to migratable fragments. These migratable fragments may cause off-odors or off-tastes in the packaged product.

In another embodiment, the oxygen scavenging polymer can be a modified vinyl alcohol polymer (mPVOH). The mPVOH can comprise a vinyl alcohol group (structure IV): 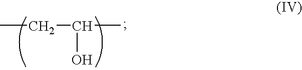
and at least one structure comprising structure V or structure VI: 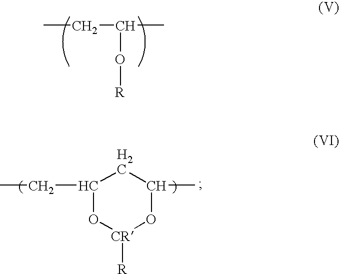
wherein R can be a group containing at least one carbon atom and at least one hydrogen atom, wherein at least one of the hydrogen atoms can be an “alpha hydrogen.” The term “alpha hydrogen” refers to a hydrogen atom bonded to a first carbon atom, wherein the first carbon atom can be also bonded to one or more of the following: (i) a second carbon atom which is double-bonded to a third carbon atom; (ii) a second carbon atom which is a member of an aromatic ring; and (iii) a second carbon atom which is bonded to an oxygen atom; and wherein R′ can independently comprise hydrogen, an unsubstituted hydrocarbon moiety, or a substituted hydrocarbon moiety.

In one embodiment, R has structure I, as described above, and each R′ in structure VI is independently hydrogen, methyl, ethyl, propyl, or butyl.

The polymer of this embodiment can further comprise units of CR³₂—CR³₂ (structure VII), wherein each R³ is independently hydrogen, methyl, ethyl, propyl, or butyl. In one embodiment, each R³ in structure VII is hydrogen.

In one embodiment, the modified vinyl alcohol polymer is modified polyvinylalcohol. In another embodiment, the modified vinyl alcohol polymer is modified ethylene vinyl alcohol polymer. The modified polyvinylalcohol and modified vinyl alcohol polymers are described in U.S. patent application Ser. No. 10/442,799, which is hereby incorporated by reference.

In another embodiment, the oxygen scavenging polymer can be a polyester polymer comprising structure II, or structure III: 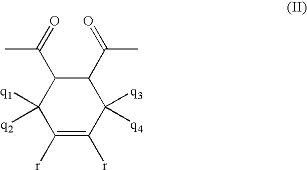
wherein q₁, q₂, q₃, q₄, and r can be independently selected from hydrogen, methyl, or ethyl. In a further embodiment, q₁, q₂, q₃, q₄, and r can be each hydrogen (i.e. the polymer can be derived from tetrahydrophthalic anhydride). 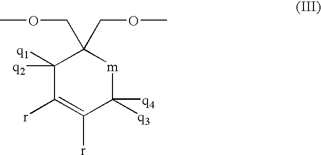
wherein q₁, q₂, q₃, q₄, and r can be independently selected from hydrogen, methyl, or ethyl; m can be —(CH₂)ₚ—, wherein p can be an integer from 0 to 4, inclusive; and, when r is hydrogen, at least one of q₁, q₂, q₃, and q₄ is also hydrogen. In one embodiment, the polymer can be derived from 3-cyclohexene-1,1-dimethanol. In yet another embodiment, the oxygen scavenger can be a polyamide comprising structure II.

In still another embodiment, the oxygen scavenging polymer can be a polyamide derived, at least in part, from monomers comprising a xylylene diamine moiety (alternatively, “xylylene diamine-based monomers”). By “xylylene diamine-based monomer” is meant any substituted or unsubstituted xylylene diamine wherein the amine groups are capable of forming polyamide linkages during polymerization with a diacid, diacid halide, etc. The polyamide can be a homopolymer derived from xylylene diamine and diacid, or a copolymer comprising any mol % of monomers comprising a xylylene diamine moiety; preferably, the polyamide comprises from about 10 mol % to about 50 mol % units derived from a xylylene diamine-based monomer.

In one embodiment, the oxygen scavenging polymer can make up from about 10 wt % to about 100 wt % of the first layer. In one embodiment, the oxygen scavenging polymer makes up from about 20 wt % to about 90 wt % of the first layer.

In embodiments wherein the oxygen scavenging polymer does not make up 100 wt % of the first layer, the first layer can comprise other polymers or additives. Other polymers that can be included in the first layer include, but are not limited to, polyethylene (PE), polyethylene terephthalate (PET), poly(ethylene/vinyl acetate) (EVA), poly(ethylene/methyl acrylate) (EMAC), polypropylene (PP), polyvinyl chloride (PVC), polystyrene (PS), ethylene/(meth)acrylate ionomers, among others, or combinations of two or more thereof. In one embodiment, the other polymer is PE, PET, EVA, or EMAC, or combinations of two or more thereof. Other polymers can be present to an extent which brings the total weight percentage of the polymers (oxygen scavenging polymer plus other polymers) in the first layer to from about 50 wt % to about 100 wt % of the first layer. In one embodiment, the total weight percentage of the polymers in the first layer can be from about 80 wt % to about 95 wt %.

In another embodiment, the first layer can further comprise an oxygen barrier polymer, wherein the oxygen barrier polymer is blended with the oxygen scavenging polymer, as discussed in copending U.S. patent application Ser. No. 09/800,418, which is hereby incorporated by reference. An oxygen barrier polymer is any polymer generally viewed as providing a barrier to oxygen passage, e.g. a 1 mil layer consisting essentially of the oxygen barrier polymer has an oxygen transmission rate of less than about 100 cc/m²/day at room temperature under 1 atm O₂ and 0% humidity. In one embodiment, the oxygen barrier polymer is selected from polymers or copolymers of vinyl alcohol (such as ethylene/vinyl alcohol copolymer (EVOH)), polyesters (such as polyethylene terephthalate (PET) or polyethylene naphthalate (PEN)), polymers or copolymers of vinylidene dichloride (such as polyvinylidene dichloride (PVDC)), polymers or copolymers of epoxies, polysulfones, polymers or copolymers of acrylonitrile (such as polyacrylonitrile (PAN)), polymers or copolymers of isocyanates, or polyamides.

In another embodiment, the oxygen barrier polymer is poly(ethylene vinyl alcohol) (EVOH). In still another embodiment, the oxygen barrier polymer is polyacrylonitrile (PAN) or a copolymer comprising acrylonitrile. In a further embodiment, the oxygen barrier polymer is poly(vinylidene dichloride) (PVDC). In yet an additional embodiment, the oxygen barrier polymer is polyethylene terephthalate (PET). In yet a further embodiment, the oxygen barrier polymer is polyethylene naphthalate (PEN). In still an additional embodiment, the oxygen barrier polymer is a polyamide other than MXD6. In yet an additional embodiment, the oxygen barrier polymer is MXD6. The polyamide can be aliphatic or aromatic. Exemplary polyamides include nylon 6; nylon 6,6; amorphous polyamide; and nylon 6,12.

Two or more oxygen barrier polymers can be used. The appropriateness of a particular oxygen barrier polymer may vary depending on the intended use of the polymer, the composition, or a packaging article made therefrom.

Additives which can be included in the first layer include, but are not limited to, compounds commonly used with oxygen scavenging polymers, in order to enhance the functionality of the oxygen scavenging polymers in storage, processing into a layer of a packaging article, or use of the packaging article. Such additives can include, but are not limited to, photoinitiators, antioxidants, dyes, or fillers, alone or in any combination of two or more thereof, among other additives which will be apparent to the skilled artisan. Exemplary additives are discussed in more detail below. The enhancements referred to above can include, but are not limited to, limiting the rate of oxygen scavenging by the oxygen scavenging polymer prior to filling of the packaging article with a product, initiating oxygen scavenging by the oxygen scavenging polymer at a desired time, limiting the induction period (the period between initiating oxygen scavenging and scavenging of oxygen at a desired rate), or rendering the layer comprising the oxygen scavenging polymer stronger or more transparent, among others.

In one embodiment, a functional absorber can be present in the first layer. Functional absorbers will be described below.

In one embodiment, the first layer comprises a transition metal organic salt. Transition metal organic salts will be described below.

In one embodiment, another compound that can be included in the first layer is a photoinitiator, or a blend of different photoinitiators. A photoinitiator may be useful if antioxidants are included in the first layer to prevent premature oxidation of the oxygen scavenging polymer. A photoinitiator generally provides faster and more efficient initiation of oxygen scavenging by the oxygen scavenging polymer. The optimal amount of photoinitiator to include will vary depending on the photoinitiator used, the wavelength and intensity of radiation, such as ultraviolet light, used to initiate, and other factors. In one embodiment, the photoinitiator is either on the U.S. Food and Drug Administration GRAS (generally regarded as safe) list, or exhibits substantially no migration from the packaging article to the product (i.e. less than 50 ppb in the product). Typically, the amount of photoinitiator, when used, can be in the range of 0.01 to 10% by weight of the first layer.

Suitable photoinitiators are well known to those skilled in the art. Specific examples include, but are not limited to, benzophenone, o-methoxybenzophenone, acetophenone, o-methoxy-acetophenone, acenaphthenequinone, methyl ethyl ketone, valerophenone, hexanophenone, α-phenyl-butyrophenone, p-morpholinopropiophenone, dibenzosuberone, 4-morpholinobenzophenone, benzoin, benzoin methyl ether, 4-o-morpholinodeoxybenzoin, p-diacetylbenzene, 4-aminobenzophenone, 4′-methoxyacetophenone, α-tetralone, 9-acetylphenanthrene, 2-acetylphenanthrene, 10-thioxanthenone, 3-acetylphenanthrene, 3-acetylindole, 9-fluorenone, 1-indanone, 1,3,5-triacetylbenzene, thioxanthen-9-one, xanthene-9-one, 7-H-benz[de]anthracen-7-one, benzoin tetrahydropyranyl ether, 4,4′-bis(dimethylamino)-benzophenone, 1′-acetonaphthone, 2′-acetonaphthone, acetonaphthone and 2,3-butanedione, benz[a]anthracene-7,12-dione, 2,2-dimethoxy-2-phenylacetophenone, α,α-diethoxyacetophenone, and α,α-dibutoxyacetophenone, among others. Singlet oxygen generating photosensitizers such as Rose Bengal, methylene blue, and tetraphenyl porphine may also be employed as photoinitiators. Polymeric initiators include poly(ethylene carbon monoxide) and oligo[2-hydroxy-2-methyl-1-[4-(1-methylvinyl)phenyl]propanone].

Photoinitiators that are especially useful in the present invention include benzophenone derivatives containing at least two benzophenone moieties, as described in U.S. Pat. No. 6,139,770. Because of their large size and low solubility, such benzophenone derivatives have a very low degree of migration from oxygen scavenging compositions, which may lead to reduced contamination of a packaged product by extracted photoinitiator.

A “benzophenone moiety” is a substituted or unsubstituted benzophenone group. Suitable substituents include alkyl, aryl, alkoxy, phenoxy, and alicylic groups contain from 1 to 24 carbon atoms or halides.

Examples of benzophenone derivatives comprising two or more benzophenone moieties include dibenzoyl biphenyl, substituted dibenzoyl biphenyl, benzoylated terphenyl, substituted benzoylated terphenyl, tribenzoyl triphenylbenzene, substituted tribenzoyl triphenylbenzene, benzoylated styrene oligomer (a mixture of compounds containing from 2 to 12 repeating styrenic groups, comprising dibenzoylated 1,1-diphenyl ethane, dibenzoylated 1,3-diphenyl propane, dibenzoylated 1-phenyl naphthalene, dibenzoylated styrene dimer, dibenzoylated styrene trimer, and tribenzoylated styrene trimer), and substituted benzoylated styrene oligomer. In one embodiment, the photoinitiator can be tribenzoyl triphenylbenzene. In one embodiment, the photoinitiator can be a substituted tribenzoyl triphenylbenzene.

The benzophenone derivatives include dimers, trimers, tetramers, and oligomers of benzophenones and substituted benzophenones.

Alternatively, the benzophenone derivatives may be represented by the formula:
Xₘ(Y)ₙ
wherein X is a bridging group selected from sulfur; oxygen; carbonyl; —SiR⁴₂—, wherein each R⁴ is individually selected from alkyl groups containing from 1 to 12 carbon atoms, aryl groups containing 6 to 12 carbon atoms, or alkoxy groups containing from 1 to 12 carbon atoms; —NR⁵—, wherein R⁵ is an alkyl group containing 1 to 12 carbon atoms, an aryl group containing 6 to 12 carbon atoms, or hydrogen; or an organic group containing from 1 to 50 carbon atoms, preferably from 1 to 40 carbon atoms; m is an integer from 0 to 11; Y is a substituted or unsubstituted benzophenone group; and n is an integer from 2 to 12.

X can be a divalent group, or a polyvalent group with 3 or more benzophenone moieties. The organic group, when present, can be linear, branched, cyclic (including fused or separate cyclic groups), or an arylene group (which can be a fused or non-fused polyaryl group). The organic group can contain one or more heteroatoms, such as oxygen, nitrogen, phosphorous, silicon, or sulfur, or combinations thereof. Oxygen can be present as an ether, ketone, ester, or alcohol.

The substituents of Y, herein R⁶, when present, are individually selected from alkyl, aryl, alkoxy, phenoxy, or alicylic groups containing from 1 to 24 carbon atoms, or halides. Each benzophenone moiety can have from 0 to 9 substituents. Substituents can be selected to render the photoinitiator more compatible with the oxygen scavenging composition.

The amount of photoinitiator in the oxygen scavenging composition or oxygen scavenging layer, when used, will be in the range of about 0.01% to about 10%, preferably about 0.01% to about 1%, by weight of the oxygen scavenging layer.

In one embodiment, antioxidants can be used in the first layer to control scavenging initiation in the oxygen scavenging polymer. An antioxidant as defined herein is a material which inhibits oxidative degradation or cross-linking of polymers. Typically, antioxidants are added to facilitate the processing of polymeric materials or prolong their useful lifetime. In relation to this invention, such additives prolong the induction period for oxygen scavenging in the absence of irradiation. When it is desired to commence oxygen scavenging by the oxygen scavenging polymer, the packaging article (and any incorporated photoinitiator) can be exposed to radiation.

Antioxidants such as 2,6-di(t-butyl)-4-methylphenol(BHT), 2,2′-methylene-bis(6-t-butyl-p-cresol), triphenylphosphite, tris-(nonylphenyl)phosphite, vitamin E, tetra-bismethylene 3-(3,5-ditertbutyl-4-hydroxyphenyl)-propionate methane, and dilaurylthiodipropionate are suitable for use with this invention.

The amount of an antioxidant which may be present may also have an effect on oxygen scavenging. As mentioned earlier, such materials are usually present in oxidizable organic compounds or structural polymers to prevent oxidation or gelation of the polymers. Typically, they are present in about 0.01 to 1% by weight of the composition. However, additional amounts of antioxidant may also be added if it is desired to tailor the induction period of the oxygen scavenging polymer.

Other additives which can be included in the first layer include, but are not necessarily limited to, fillers, pigments, dyestuffs, stabilizers, processing aids, plasticizers, fire retardants, anti-fog agents, or two or more of the foregoing, among others.

In one embodiment, any of these other additives employed normally will not comprise more than about 10% by weight of the first layer, such as less than about 5% by weight of the first layer.

The first layer can have any thickness. In one embodiment, the thickness of the first layer is from about 0.1 mil to about 10 mil. In a further embodiment, the thickness of the first layer is from about 0.2 mil to about 5 mil. In yet a further embodiment, the thickness of the first layer is from about 0.5 mil to about 2 mil.

As stated above, the packaging article comprises a second layer. The second layer can make up at least a portion of the thickness of the packaging article underlying at least a portion of the surface area. The second layer can comprise a functional barrier polymer.

A “functional barrier polymer” is any polymer of which a layer consisting essentially thereof impedes the migration of one or more migratable compounds through such layer. A “functional barrier polymer” need not impede the migration of all migratable compounds, nor need it completely impede the migration of any one migratable compound, in order to meet the definition given above. In some embodiments, mixtures of functional barrier polymers may be used.

Functional barrier polymers can include, but are not limited to, polymers at least in part derived from a propylene monomer (such as polypropylene), polymers derived at least in part from a vinyl acetate monomer (such as ethylene/vinyl acetate copolymers), polymers derived at least in part from a butyl acrylate monomer, polymers derived at least in part from an acrylic acid or a methacrylic acid monomer, ionomers derived from acrylic acid monomer or methacrylic acid monomer, polyethylene terephthalate glycol (PETG), and amorphous nylon, or a mixture of two or more thereof, among others. Polyethylene terephthalate and nylon 6 are disclosed as barrier polymers by Ching et al., PCT Publ. Appln. WO 96/08371.

“Migratable,” as used herein, refers to compounds or molecules which have less than about 50 atoms and are generally gaseous or liquid at about 0° C. to about 40° C. and ambient pressure. The migratable compounds may possess a detectable odor, a detectable taste, both, or neither.

In one embodiment, a functional barrier polymer can be oriented, which may enhance the functional barrier properties of the polymer.

In one embodiment, the functional barrier polymer is polypropylene. In another embodiment, the functional barrier polymer is oriented polypropylene.

In one embodiment, the second layer can comprise from about 20 wt % to about 100 wt % of the functional barrier. In another embodiment, the second layer can comprise from about 50 wt % to about 100 wt % of the functional barrier polymer. In another embodiment, the second layer can comprise 70 wt % to about 100 wt % of the functional barrier polymer. In a further embodiment, the second layer can comprise from about 80 wt % to about 100 wt % of the functional barrier polymer. In yet a further embodiment, the second layer can comprise from about 90 wt % to about 100 wt % of the functional barrier polymer.

In embodiments wherein the second layer is not made up of 100 wt % of the functional barrier polymer, the second layer can comprise other polymers or additives. Other polymers that can be included in the second layer include, but are not limited to, polyethylene (PE), polyethylene terephthalate (PET), poly(ethylene/vinyl acetate) (EVA), poly(ethylene/methyl acrylate) (EMAC), polypropylene (PP), polyvinyl chloride (PVC), polystyrene (PS), ethylene/(meth)acrylate ionomers, among others, or combinations of two or more thereof. In one embodiment, the other polymer is PE, PET, EVA, or EMAC, or combinations of two or more thereof. Other polymers can be present to an extent which brings the total weight percentage of the polymers (functional barrier polymer plus other polymers) in the second layer to from about 95 wt % to about 100 wt % of the second layer. In one embodiment, the total weight percentage of the polymers in the second layer can be from about 98 wt % to about 100 wt %.

Additives which can be included in the second layer include those which can improve the functionality of the functional barrier layer or the packaging article as a whole.

In one embodiment, a functional absorber can be present in the second layer. Functional absorbers will be described below.

In one embodiment within the set of embodiments wherein the second layer is adjacent to the first layer, the second layer can comprise a transition metal organic salt. Transition metal organic salts will be described below.

The second layer can have any thickness. In one embodiment, the second layer has a thickness from about 0.1 mil to about 10 mil. In a further embodiment, the thickness of the second layer is from about 0.2 mil to about 5 mil. In yet a further embodiment, the thickness of the second layer is from about 0.5 mil to about 2 mil.

In one embodiment, the second layer covers both (i) at least as much surface area of the packaging article as does the first layer and (ii) at least the entire surface area of the first layer. In one embodiment, the second layer covers the entire inner surface area of the packaging article. “Cover” in this context can, but need not, mean that the second layer itself provides the inner surface of the packaging article.

In one embodiment, the packaging article can comprise a functional absorber. The functional absorber can be any compound which at least partially neutralizes or at least partially sequesters at least one migratable compound. A functional absorber need not at least partially neutralize or at least partially sequester all migratable compounds. A functional absorber need not fully neutralize or fully sequester one or more migratable compounds.

Functional absorbers that can be used in the present invention include, but are not limited to, those disclosed by Ching et al., U.S. Pat. No. 6,057,013; Blinka et al., U.S. Pat. No. 6,391,403; and WO97/32925, the disclosures of which are hereby incorporated by reference. In one embodiment, the functional absorber can be a zeolite, a molecular sieve with a framework structure enclosing cavities which can be occupied by large ions, water molecules, or migratable compounds. In a further embodiment, the functional absorber can be a powdered zeolite, such as are known under the trade names Abscent 1000™, Abscent 2000™, or Abscent 3000™ (commercially available from UOP, Des Plaines, Ill.), among others. The Abscent™ functional absorbers are disclosed by U.S. Pat. Nos. 4,795,482; 5,013,335; and 4,855,154, which are hereby incorporated by reference. Other functional absorbers include silicates, activated carbons (such as activated carbon strips commercially available from MeadWestvaco, among others), aluminas, or mixtures thereof, among others.

The functional absorber may or may not act neutralize or sequester the same migratable compound or compounds as are impeded by the functional barrier polymer. The functional absorber may be active against a different migratable compound or compounds than those impeded by the functional barrier polymer. Additionally, the functional absorber may be considered as an additional form of protection further to that provided by the functional barrier polymer.

The functional absorber can be located in any layer of the packaging article. In one embodiment, the functional absorber is located in the first layer. In one embodiment, the functional absorber is located in the second layer. In one embodiment, the functional absorber is located between the first layer and the second layer. In one embodiment, the functional absorber is located in a layer other than the first layer and the second layer. Embodiments in which the functional absorber is located in specific layers of the packaging article will be described below.

In one embodiment, the functional absorber is dispersed in a polymer. In another embodiment, the functional absorber is dispersed within a polymer layer of the packaging article.

In one embodiment, the functional absorber can be evenly distributed in a layer of the packaging article. In another embodiment, the functional absorber can have a concentration gradient from a minimum value to a maximum value across a layer of the packaging article. In yet another embodiment, the functional absorber has a concentration gradient across a layer of the packaging article from a minimum value on the side closest to the package interior to a maximum value to the side closest to the first layer. In another embodiment, the functional absorber has a concentration gradient across a layer of the packaging article from a maximum value on the side closest to the first layer to a minimum value to the side closest to the package exterior.

As stated above, the packaging article comprises a transition metal organic salt. The transition metal organic salt can be any ionic compound formed from a transition metal ion and an organic counterion. The transition metal functions to catalyze oxygen scavenging by the oxygen scavenging polymer, increasing the rate of scavenging and reducing the induction period. Though not to be bound by theory, useful transition metals include those which can readily interconvert between at least two oxidation states. See Sheldon, R. A.; Kochi, J. K.; “Metal-Catalyzed Oxidations of Organic Compounds” Academic Press, New York 1981.

In one embodiment, the transition metal can be selected from the first, second or third transition series of the Periodic Table. Suitable metals include, but are not limited to, manganese, iron, cobalt, nickel, copper, rhodium, and ruthenium. The oxidation state of the transition metal when introduced need not necessarily be that of the active form. In one embodiment, the transition metal can be iron, nickel, manganese, cobalt or copper; in a further embodiment, manganese or cobalt; and in yet a further embodiment, cobalt.

Charged, carbon-containing compounds can provide the organic counterion of the transition metal organic salt. Suitable counterions for the metal include, but are not limited to, acetate, oleate, stearate, palmitate, 2-ethylhexanoate, neodecanoate, naphthenate, behenate, arachidate, or ionomers. In one embodiment, the organic counterion is a carboxylate, i.e., comprises a —COO— moiety. In a further embodiment, the counterion is selected from C₁-C₂₀ alkanoates. It can be desirable for the salt, the transition metal, and the counterion to be either on the U.S. Food and Drug Administration GRAS (generally regarded as safe) list, or exhibit substantially no migration from the packaging article to the product (i.e. less than about 500 ppb, preferably less than about 50 ppb, in the product). However, such conditions are not necessary.

In one embodiment, the transition metal organic salt is cobalt oleate. In one embodiment, the transition metal organic salt is cobalt stearate. In one embodiment, the transition metal organic salt is cobalt neodecanoate. In another embodiment, the transition metal organic salt is cobalt behenate.

In another embodiment, the transition metal organic salt can have at least one carboxylate group, wherein each carboxylate group comprises between 20 and 30 carbon atoms, inclusive. In some embodiments, the compositions of the present invention comprise carboxylate groups having 20 to 26 carbon atoms, and in certain embodiments, the carboxylate groups have 20 to 22 carbon atoms. In some embodiments, the carboxylate groups have an even number of carbon atoms. The transition metal carboxylate is saturated, in certain embodiments. Examples of such carboxylates are transition metal behenates (alternatively called docosenates) and transition metal arachidates (alternatively called eicosanates).

Suitable transition metal behenates are commercially available from Shepherd Chemical Company, Cincinnati, Ohio. Certain C₂₀ through C₃₀ carboxylates can be synthesized by reacting a C₂₀ through C₃₀ carboxylic acid, or a mixture of C₂₀ through C₃₀ carboxylic acids, with a transition metal hydroxide. For example, one suitable procedure for synthesizing behenates or arachidates involves reacting about two moles of arachidic acid or behenic acid with about one mole of transition metal hydroxide (e.g., cobalt hydroxide).

Typically, the amount of transition metal may range from 0.001 wt % to 10 wt % (10 to 100,000 ppm) of the layer in which it is found, based on the metal content only (excluding ligands, counterions, etc.).

The transition metal organic salt can be located in at least one of the first layer or a layer adjacent to the first layer. If the second layer is adjacent to the first layer, the transition metal organic salt can be located in the second layer.

Any arrangement of the first layer, the second layer, and other layers, if any, of the packaging article is within the scope of the present invention, provided the second layer is located between the first layer and the package interior. By “located between” is meant that a notional line segment (i) starting at any point on the inner surface of the first layer, (ii) orthogonal to the first layer, and (iii) in the direction of the package interior, would intersect the second layer.

In one embodiment, the second layer may be permeable to oxygen. In another embodiment, the second layer may be impermeable to oxygen.

In addition to the first layer and the second layer, as described above, in one embodiment, the packaging article can comprise other layers.

In one embodiment, wherein one or more other layers are located between the package interior and the first layer, each of the one or more other layers independently may be permeable to oxygen or may be impermeable to oxygen.

In one embodiment, the packaging article can comprise a third layer, containing a structural material. The third layer can be located at any point in the packaging article. In one embodiment, the third layer can be located between the second layer and the package interior. In another embodiment, the third layer can be located between the first layer and the package exterior. In a further embodiment, the third layer can be the outermost layer of the packaging article, i.e., the third layer is located between the first layer and the package exterior and is in contact with the package exterior.

A structural material is any material which, when present in or making up at least one layer of a packaging article, can help impart a physical property or properties to the packaging article which improves the packaging article's suitability for a particular use. For example, if the packaging article is a rigid container, the third layer comprising the structural material can improve the rigidity of the packaging article.

A structural material can, but need not, also be useful in food contact, and thus, in one embodiment, the third layer can be a food contact layer.

In one embodiment, the structural material can be a structural polymer. The structural polymer can be polyethylene (PE), polyethylene terephthalate (PET), poly(ethylene/vinyl acetate) (EVA), poly(ethylene/methyl acrylate) (EMAC), polypropylene (PP), polyvinyl chloride (PVC), polystyrene (PS), ethylene/(meth)acrylate ionomers, or styrenelbutadiene copolymers, among others, or combinations of two or more thereof. In one embodiment, the structural polymer can be PE, PET, EVA, or EMAC, or combinations of two or more thereof. In one embodiment, the structural polymer can make up from about 50 wt % to about 100 wt % of the third layer. In one embodiment, the structural polymer can make up from about 75 wt % to about 100 wt % of the third layer. In one embodiment, the structural polymer can make up from about 90 wt % to about 100 wt % of the third layer.

In another embodiment, the structural material can be selected from paper, cardboard, paperboard, or foil. In one embodiment, the structures comprising the first and second layers can be extrusion coated onto the structural material. In another embodiment, the structures comprising the first and second layers can be laminated onto the structural material. Either of these embodiments can be used in the preparation of gable-top paperboard containers for juice.

In one embodiment, the third layer can comprise other polymers or additives. Such other polymers or additives can be selected by the skilled artisan as a matter of routine experimentation.

In one embodiment, the third layer contains a functional absorber, described above.

The third layer can have any thickness. In one embodiment, the third layer has a thickness from about 0.1 mil to about 10 mil. In a further embodiment, the thickness of the third layer is from about 0.2 mil to about 5 mil. In yet a further embodiment, the thickness of the third layer is from about 0.5 mil to about 2 mil.

The packaging article can also comprise a fourth layer, containing a gas barrier material, wherein the fourth layer is located between the first layer and the package exterior. The term “fourth layer” does not mean that the third layer, described above, must be included in the packaging article of this embodiment. In other words, both (i) a packaging article comprising a first layer, a second layer, and a fourth layer and (ii) a packaging article comprising a first layer, a second layer, a third layer, and a fourth layer, as those layers are described herein, are within the scope of the present invention according to this embodiment.

The gas barrier material in the fourth layer can be any material which is substantially impermeable to oxygen, carbon dioxide, and other molecules of similar size (from 1 to about 5 atoms) and volatility (having boiling points below about 0° C.). In one embodiment, the gas barrier material can be poly(ethylene vinyl alcohol) (EVOH), polyacrylonitrile (PAN), a copolymer comprising acrylonitrile, poly(vinylidene dichloride) (PVDC), polyethylene terephthalate (PET), polyethylene napthalate (PEN), a polyamide, a metal foil, or a mixture of two or more thereof.

In one embodiment, the fourth layer can comprise other polymers or additives. Such other polymers or additives can be selected by the skilled artisan as a matter of routine experimentation.

In one embodiment, the fourth layer can contain a functional absorber, described above.

The fourth layer can have any thickness. In one embodiment, the fourth layer has a thickness from about 0.1 mil to about 10 mil. In a further embodiment, the thickness of the fourth layer is from about 0.2 mil to about 5 mil. In yet a further embodiment, the thickness of the fourth layer is from about 0.5 mil to about 2 mil.

In other embodiments, the packaging article can also comprise other layers not explicitly described above, but which the skilled artisan would consider, either from his or her understanding of the art or as a result of routine experimentation, for use in a packaging article as described herein. Such other layers can include, but are not limited to, seal layers and adhesive layers, among others. In some embodiments, the seal layer contains the functional absorber.

In one embodiment, the packaging article contains 5 layers having an A/B/C/B/A arrangement wherein A is a food contact layer, B is a layer containing the functional absorber and a carrier polymer, and C is a layer containing the oxygen scavenging polymer. In a further embodiment, layers A and B are combined wherein the functional absorber has an increasing concentration gradient from a minimum value at the package interior contact point to a maximum value at the C layer contact point. The layer A and the functional absorber carrier polymer can include, but are not limited to, PE, PP, EMAC, EVA, styrene/butadiene, or mixtures thereof, among others. The functional absorbers can include, but are not limited to, zeolites (such as powdered zeolites, such as Abscents 1000, Abscents 2000, or Abscents 3000), silicates, activated carbons (such as activated carbon papers, such as are commercially available from MeadWestvaco), aluminas, or mixtures thereof, among others.

In a further embodiment, the packaging article contains the above 5-layer arrangement and a structural layer containing a material such as, but not limited to, paper, paperboard, PP, PET, or foil, among others. A gas barrier layer, containing a material such as, but not limited to, EVOH, PVDC, or nylon, among others, can also be present. A tie layer, such as one containing Bynel or grafted maleic anhydride copolymer, among others, can be included between the 5-layer arrangement and the structural layer or the gas barrier layer.

In one embodiment, the packaging article comprises at least one oxygen scavenging layer, a functional absorber layer which consists of an adsorptive paper/film, wherein the functional absorber layer can be adjacent to one or sandwiched between two oxygen scavenging layer(s), and at least one functional barrier layer between (i) the combined oxygen scavenging layer(s) and functional absorber layer, and (ii) the package interior. The adsorptive paper/film can include, but is not limited to, an activated carbon paper product (such as is commercially available from MeadWestvaco, Stamford, Conn.), among others. The functional barrier layer can comprise a functional barrier polymer, such as low-density polyethylene or polypropylene, among other polymers. In one embodiment, the oxygen scavenging layer, functional absorber layer, and functional barrier layer can be in the form of a ribbon or insert placed in a packaging article.

In one embodiment, shown in FIG. 1, a packaging article 100 comprises, in order from package interior 120 to package exterior 140, (i) a third layer 102 comprising a structural polymer and, optionally, a functional absorber; (ii) a second layer 104 comprising a functional barrier polymer; and (iii) a first layer 106 comprising an oxygen scavenging polymer and a transition metal organic salt. In a further embodiment, the packaging article 100 further comprises (iv) a fourth layer 108 comprising a structural material.

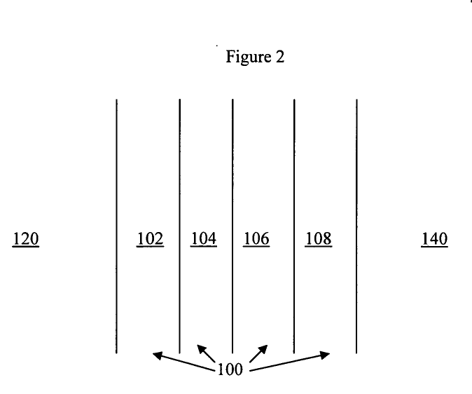

In a further embodiment, shown in FIG. 2, the packaging article 100 comprises, in order from package interior 120 to package exterior 140, (i) a third layer 102 of about 1 mil thickness and comprising about 90 wt % PE, EVA, or EMAC and about 10 wt % of Abscent 1000, Abscent 2000, or Abscent 3000; (ii) a second layer 104 of about 1 mil thickness and comprising about 100 wt % of PP or PE; and (iii) a first layer 106 of about 1 mil thickness and comprising about 90 wt % EMCM and about 10 wt % cobalt oleate. In a further embodiment, the packaging article 100 further comprises (iv) a fourth layer 108 comprising paperboard.

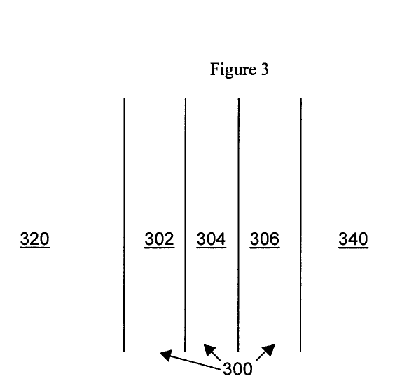

In another embodiment, shown in FIG. 3, a packaging article 300 comprises, in order from package interior 320 to package exterior 340, (i) a second layer 302 comprising a functional barrier polymer and (ii) a first layer 304 comprising an oxygen scavenging polymer and a transition metal salt. In a further embodiment, the packaging article further comprises (iii) a fourth layer 306 comprising a structural material.

All the embodiments shown in the figures may further comprise other layers not depicted in the figures, such as heat seal layers or adhesive layers, among others.

In another embodiment the present invention relates to a method of packaging a food or a beverage. The method can comprise sealing the food or the beverage in a packaging article defining a package interior and a package exterior, and comprising (i) a first layer, containing an oxygen scavenging polymer comprising (a) an ethylenic backbone or a polyester backbone and (b) at least one cyclic olefinic group; (ii) a second layer, containing a functional barrier polymer; and (iii) a transition metal organic salt in at least one of the first layer or a layer adjacent to the first layer. The second layer is located between the first layer and the package interior.

Techniques for selecting a packaging article for packaging a particular food or beverage and sealing the food or the beverage in a packaging article are known to the skilled artisan.

The following examples are included to demonstrate certain embodiments of the invention. It should be appreciated by those of skill in the art that the techniques disclosed in the examples which follow represent techniques discovered by the inventor to function well in the practice of the invention. However, in light of the present disclosure, those of skill in the art should appreciate that many changes can be made in the specific embodiments which are disclosed and still obtain a like or similar result without departing from the spirit and scope of the invention.

### EXAMPLES 1-5

### Oxygen Scavenging and Sensory Assays of Films

The following films were prepared and examined in this study:

| Example | Film Composition |
|---|---|
| 1 | 0.5 mil (90% LDPE + 10% Abscent 1000)/0.5 mil PP/1 |
| | mil oxygen scavenger/0.5 mil PP/0.5 mil (90% LDPE + 10% |
| | Abscent 1000) |
| 2 | 0.5 mil (90% LDPE + 10% Abscent 1000)/0.5 mil LDPE/1 |
| | mil oxygen scavenger/0.5 mil LDPE/0.5 mil (90% LDPE + |
| | 10% Abscent 1000) |
| 3 | 0.5 mil (90% LDPE + 10% Abscent 3000)/0.5 mil PP/1 mil |
| | oxygen scavenger/0.5 mil PP/0.5 mil (90% LDPE + 10% |
| | Abscent 3000) |
| 4 | 0.5 mil (90% LDPE + 10% Abscent 3000)/0.5 mil LDPE/1 |
| | mil oxygen scavenger/0.5 mil LDPE/0.5 mil (90% LDPE + |
| | 10% Abscent 3000) |
| 5 | 0.5 mil LDPE/0.5 mil LDPE/1 mil LDPE/0.5 mil |
| | LDPE/0.5 mil LDPE |

In the table,
“LDPE” is a low density polyethylene;
“PP” is a polypropylene; and
“oxygen scavenger” is a composition containing 90% poly(ethylene/methyl acrylate/cyclohexenylmethyl acrylate), cobalt oleate, and a photoinitiator.

The samples were prepared for an oxygen scavenging assay by the following procedure:
1. Samples of 100 cm were made from each of the films. Each sample was irradiated with 800 mJ of UV light (peak wavelength 254 nm).
2. Each sample was sealed into a 300 mL atmosphere comprising about 20.5% oxygen.
3. Samples were stored in at 4° C.
4. Headspace oxygen concentration in the sealed atmospheres was measured at various times on 5 mL extracts taken from each sealed atmosphere.

Results of the oxygen scavenging assay are as follows:

| | | O₂ % at | O₂ % at | O₂ % at | O₂ % at | O₂ % at |
|---|---|---|---|---|---|---|
| Example | O₂ % at 0 hr | 1 day | 3 days | 8 days | 14 days | 23 days |
| 1 | 20.5 | 20.5 | 20.3 | 19 | 19.2 | 19.1 |
| 2 | 20.5 | 20.5 | 19. | 17.9 | 17.6 | 16.5 |
| 3 | 20.5 | 20.5 | 19.2 | 18.3 | 18 | 17.9 |
| 4 | 20.5 | 20.3 | 18.8 | 17.9 | 16.8 | 16.4 |
| 5 | 20.4 | 20.5 | 20.5 | 20.5 | 20.5 | n.d. |

n.d., not determined

The scavenging results showed that samples containing polypropylene as a functional barrier polymer exhibited scavenging at a slower rate and to a lesser extent.

Samples were prepared for sensory testing by the following procedure:
1. Films were irradiated with 800 mJ of UV light (peak wavelength 254 nm).
2. 4″×10″ pouches were formed from each film.
3. The pouches were filled with 400 cc spring water from glass bottles, and sealed.
4. The sealed water pouches were placed in larger foil pouches.
5. 400 cc of 21% oxygen were introduced to the headspace of the foil pouch, and the foil pouches were stored at room temperature.
6. Headspace oxygen concentrations were measured according to the procedure given above.
7. The sensory properties of the water were measured at about 20 days.

The oxygen scavenging results generally paralleled those of the previous assay:

| | Headspace | Headspace | Headspace | Headspace | Headspace |
|---|---|---|---|---|---|
| | O₂ %, | O₂ %, | O₂ %, | O₂ %, | O₂ %, |
| Time (days) | Example 1 | Example 2 | Example 3 | Example 4 | Example 5 |
| 0.0 | 21.4 | 21.4 | 21.4 | 21.4 | 21.4 |
| 1.0 | 18.1 | 15.0 | 15.7 | 14.0 | 21.0 |
| 1.9 | 17.8 | 13.9 | 14.6 | 12.4 | 20.8 |
| 2.8 | 17.8 | 13.3 | 14.2 | 11.8 | 21.2 |
| 6.8 | 17.1 | 11.6 | 13.0 | 10.2 | 20.5 |
| 13.8 | 16.8 | 11.2 | 12.8 | 9.8 | 20.9 |
| 20.8 | 16.7 | 10.9 | 12.5 | 9.4 | 20.4 |
| 27.7 | 16.1 | 10.5 | 12.1 | 9.0 | 20.0 |

Sensory Testing:

Analysts were asked to rank the flavor of each water sample from 1 to 5, 1 being most preferred and 5 being least preferred. Average flavor preference rankings are provided below:

| Example | Average Flavor Preference |
|---|---|
| 1 | 2.0 |
| 2 | 5.0 |
| 3 | 2.75 |
| 4 | 4.00 |
| 5 | 1.25 |

In conclusion, the samples with polypropylene as a functional barrier polymer exhibited preferred flavor properties.

Overall, we conclude the samples with polypropylene as a functional barrier polymer represent a good compromise between rate and extent of oxygen scavenging on the one hand and optimal flavor properties of packaged foods or beverages on the other.

### EXAMPLES 6-11

### Sensory Testing of Inserts Containing Oxygen Scavenger and Odor Absorbing Layers

Inserts containing an oxygen scavenging composition substantially similar to that used in Examples 1-5 and an odor-absorbing activated carbon paper layer were formed by the following procedure:
1. Activate an oxygen scavenger film, along the lines of the activation performed in Examples 1-5.
2. Form an insert containing a 3″×6″ activated carbon paper (JDHS-3 or JDHS-4, MeadWestvaco) or control, sandwiched between two oxygen scavenger film portions or controls of the same size as the activated carbon paper, and then overwrap the sandwich with a 1.5 mil thick PE overwrap.
3. Fill an LDPE pouch with 500 cc spring water from a glass bottle, or orange juice.
4. Seal the insert in the LDPE pouch.
5. Place the LDPE pouch in a larger foil pouch.
6. Establish a headspace in the foil pouch of 400 cc of air (about 21% O₂) and store at about 4° C.

The properties of the examples are given below:

| Example | Activated Carbon Material | Oxygen Scavenger Material |
|---|---|---|
| 6 | JDHS-3 | yes |
| 7 | JDHS-4 | yes |
| 8 | JDHS-3 | no |
| 9 | JDHS-4 | no |
| 10 | none | yes |
| 11 | none | no |

The inserts containing the oxygen scavenger composition (Examples 6, 7, and 10) all exhibited comparable oxygen scavenging properties when storing water, reducing the original headspace oxygen concentration of about 21.4% to about 8%-11% after about 32 days (not shown). The inserts not containing the oxygen scavenger composition (Examples 8, 9, and 11) all exhibited the expected lack of oxygen scavenging (not shown). When orange juice was stored, the results were comparable, except that all samples experienced an extra 2%-6% reduction in headspace oxygen (i.e., Examples 6, 7, and 10 reduced the headspace oxygen concentration to about 7%-9.5%, and Examples 8, 9, and 11 reduced the headspace oxygen concentration to about 16%) (not shown). Though not to be bound by theory, it is plausible that ascorbic acid and other oxygen-reactive materials in the orange juice reacted with oxygen to reduce the headspace oxygen concentration in all the samples.

Sensory rankings of all the Examples were performed. Examples 6-9 and 11, which all either (i) contained an activated carbon functional absorber or (ii) did not contain oxygen scavenger, received the best possible ranking when water was the stored material, with any differences between them being negligible. However, the testing panel was unanimous in finding Example 10, containing oxygen scavenger but no activated carbon functional absorber, to be unacceptable in its odor and taste profiles of the stored water.

Regarding orange juice, Examples 9 and 1 1, which both did not contain oxygen scavenger, received very good rankings when orange juice was the stored product. Examples 6-8, containing at least a functional absorber and, in Examples 6-7, also containing an oxygen scavenger, were ranked as having slightly poorer sensory rankings. Again, Example 10, containing oxygen scavenger but no activated carbon functional absorber, was found to be unacceptable in its odor and taste profiles of the stored orange juice.

From this, we conclude that inserts containing an oxygen scavenging layer and a functional absorber layer are capable of scavenging oxygen in a packaging article without leading to unacceptable sensory profiles for products stored in the packaging article.

### EXAMPLES 12-20

### Oxygen Scavenging and Sensory Assays of Films

Materials

The following oxygen scavenger/functional barrier films were examined in this study.

| Example | Film Description |
|---|---|
| 12 | 0.25 mils LLDPE/0.5 mils LLDPE/1 mil |
| | oxygen scavenger/0.5 mils LLDPE/0.25 mils |
| | LLDPE |
| 13 | 0.25 mils LLDPE/0.5 mils PP/1 mil oxygen |
| | scavenger/0.5 mils PP/0.25 mils LLDPE |
| 14 | 0.25 mils (85% LLDPE + 15% absorber1)/0.5 |
| | mils PE/1 mil oxygen scavenger/0.5 mils PE/ |
| | 0.25 mils (85% LLDPE + 15% absorber1) |
| 15 | 0.25 mils (85% LLDPE + 15% absorber1)/0.5 |
| | mils PP/1 mil oxygen scavenger/0.5 mils PP/ |
| | 0.25 mils (85% LLDPE + 15% absorber1) |
| 16 | 0.25 mils (85% LLDPE + 15% absorber1)/0.25 |
| | mils PP/1 mil oxygen scavenger/0.25 mils PP/ |
| | 0.25 mils (85% LLDPE + 15% absorber1) |
| 17 | 0.25 mils (85% EVA9 + 15% absorber2)/0.5 |
| | mils PP/1 mil oxygen scavenger/0.5 mils PP/ |
| | 0.25 mils (85% EVA9 + 15% absorber2) |
| 18 | 0.5 mils PP/0.25 mils (85% EVA9 + 15% |
| | absorber2)/1 mil oxygen scavenger/0.25 mils |
| | (85% EVA9 + 15% absorber2)/0.5 mils PP |
| 19 | 0.25 mils PP/0.25 mils (85% EVA9 + 15% |
| | absorber2)/1 mil oxygen scavenger/0.25 mils |
| | (85% EVA9 + 15% absorber2)/0.25 mils PP |
| 20 | 1.5 mils PE, No UV |

LLDPE, Linear low-density polyethylene;
oxygen scavenger, 90% Chevron Phillips Chemical OSP500R ethylene/methyl acrylate/cyclohexenyl methyl acrylate + 10% cobalt/photoinitiator masterbatch (1% Co, 1% tribenzoyl triphenylbenzene in ethylene/methyl acrylate);
PP, polypropylene;
absorber1, 10% Abscents ™ 2000 zeolite in low density polyethylene;
absorber2, 10% Abscents ™ 2000 zeolite in ethylene/vinyl acetate copolymer, 10 wt % vinyl acetate;
EVA9, ethylene/vinyl acetate copolymer, 9 wt % vinyl acetate;
PE, low density polyethylene

The films 12-20 were prepared for the tests as follows:
1. An 8″×8″ pouch was made with each of the films. The outside of the pouch was activated for 2 minutes by exposing to UV, if indicated above.
2. Each pouch was filled with 500 cc of Minute Maid™ Pulp Free Orange Juice.
3. The orange juice pouch was sealed and residual air was removed.
4. 100 cc of air was injected into the orange juice pouch.
5. The orange juice pouch was sealed within a larger foil pouch
6. A headspace of 600 cc air was established in the larger foil pouch
7. Samples were stored in the refrigerator for 5 weeks and headspace oxygen concentration in the foil pouch was monitored.
8. Sensory testing was performed five weeks after the setup.
   Results
   Oxygen Scavenging

After 34 days, the headspace oxygen concentration of the oxygen scavenger containing samples ranged from 10.3% to 12.4%. The headspace concentration of the aging orange juice sample (Example 20) was 17.9%. Example 16 scavenged at the fastest rate and Example 12 scavenged at the slowest rate. Complete data is provided below.

| Time | Examples | | | | | | | | |
|---|---|---|---|---|---|---|---|---|---|
| (Days) | 12 | 13 | 14 | 15 | 16 | 17 | 18 | 19 | 20 |
| 0.0 | 21.4 | 21.4 | 21.4 | 21.4 | 21.4 | 21.4 | 21.4 | 21.4 | 21.4 |
| 1.0 | 21.1 | 21.1 | 20.7 | 21.2 | 20.8 | 21.0 | 20.9 | 21.1 | 21.0 |
| 1.8 | 20.8 | 20.8 | 20.6 | 20.8 | 19.7 | 20.8 | 20.8 | 20.6 | 20.8 |
| 5.9 | 20.3 | 19.1 | 18.0 | 20.1 | 15.3 | 19.3 | 18.0 | 16.7 | 20.4 |
| 13.2 | 19.0 | 17.0 | 14.2 | 17.8 | 12.8 | 15.7 | 14.9 | 13.2 | 19.4 |
| 19.9 | 16.7 | 14.8 | 12.0 | 16.0 | 11.9 | 13.4 | 13.4 | 12.0 | 18.9 |
| 26.9 | 15.0 | 13.3 | 11.2 | 14.3 | 11.6 | 11.8 | 13.0 | 12.0 | 18.9 |
| 33.9 | 12.4 | 12.0 | 10.3 | 12.0 | 10.9 | 10.6 | 12.0 | 11.7 | 17.9 |

Sensory Testing

Analysts A-E were asked to test the headspace aroma and flavor of the orange juice in each example. At the end of the session, each panelist was asked to rank the examples from most preferred to least preferred, with 1=most preferred. Individual and average flavor preference rankings are provided below:

Analyst Flavor Preference Ranking (1 = most preferred)

| Sample | A | B | C | D | E | Average |
|---|---|---|---|---|---|---|
| 12 | 7 | 8 | 8 | 8 | 7 | 7.6 |
| 13 | 1 | 1 | 1 | 1 | 4 | 1.6 |
| 14 | 9 | 9 | 9 | 9 | 8 | 8.8 |
| 15 | 7 | 5 | 5 | 6 | 4 | 5.4 |
| 16 | 6 | 4 | 2 | 4 | 2 | 3.6 |
| 17 | 3 | 2 | 3 | 1 | 2 | 2.2 |
| 18 | 3 | 7 | 4 | 1 | 1 | 3.2 |
| 19 | 3 | 3 | 7 | 4 | 4 | 4.2 |
| 20 | 2 | 6 | 6 | 7 | Not Tested | 5.25 |

All of the articles disclosed and claimed herein can be made and executed without undue experimentation in light of the present disclosure. While the compositions and methods of this invention have been described in terms of preferred embodiments, it will be apparent to those of skill in the art that variations may be applied to the articles described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

1. A packaging article, defining a package interior and a package exterior, and comprising:
a first layer, containing an oxygen scavenging polymer;
a second layer, containing a functional barrier polymer; and
a transition metal organic salt in at least one of the first layer or a layer adjacent to the first layer;
wherein the second layer is located between the first layer and the package interior, and
the oxygen scavenging polymer comprises (i) an ethylenic backbone or a polyester backbone and (ii) at least one cyclic olefinic group.

2. The packaging article of claim 1, wherein the oxygen scavenging polymer comprises (i) an ethylenic backbone and (ii) pendant or terminal cyclic olefinic groups.

3. The packaging article of claim 2, wherein the oxygen scavenging polymer is poly(ethylene/vinyl cyclohexene) (EVCH), ethylene/methyl acrylate/cyclohexenyl methyl acrylate terpolymer (EMCM), poly(cyclohexenyl methyl methacrylate) (CHMA), poly(cyclohexenyl methyl acrylate) (CHAA), or a mixture of two or more thereof.

4. The packaging article of claim 1, wherein the oxygen scavenging polymer is a modified vinyl alcohol polymer.

5. The packaging article of claim 1, wherein the oxygen scavenging polymer comprises a polyester backbone.

6. The packaging article of claim 1, wherein the functional barrier polymer is a polymer at least in part derived from a propylene monomer, a polymer derived at least in part from a vinyl acetate monomer, a polymer derived at least in part from a butyl acrylate monomer, a polymer derived at least in part from an acrylic acid or a methacrylic acid monomer, an ionomer derived from acrylic acid monomer or methacrylic acid monomer, polyethylene terephthalate glycol (PETG), amorphous nylon, or a mixture of two or more thereof.

7. The packaging article of claim 6, wherein the functional barrier polymer is polypropylene.

8. The packaging article of claim 6, wherein the functional barrier polymer is oriented.

9. The packaging article of claim 1, further comprising a functional absorber.

10. The packaging article of claim 9, wherein the functional absorber is a zeolite, a powdered zeolite, a silicate, an activated carbon, an alumina, or a mixture of two or more thereof.

11. The packaging article of claim 10, wherein the functional absorber is a powdered zeolite.

12. The packaging article of claim 9, wherein the functional absorber is in at least one of the first layer or the second layer.

13. The packaging article of claim 12, wherein the functional absorber is located in the first layer.

14. The packaging article of claim 12, wherein the functional absorber is located in the second layer.

15. The packaging article of claim 1, wherein the transition metal organic salt is cobalt oleate, cobalt stearate, cobalt neodecanoate, cobalt behenate, cobalt arachidate, or a mixture of two or more thereof.

16. The packaging article of claim 15, wherein the transition metal organic salt is cobalt behenate, cobalt arachidate, or a mixture of two or more thereof.

17. The packaging article of claim 1, wherein the first layer further comprises a photo initiator.

18. The packaging article of claim 1, further comprising a third layer, containing a structural material.

19. The packaging article of claim 18, wherein the third layer is between the first layer and the package interior.

20. The packaging article of claim 18, wherein the third layer is between the first layer and the package exterior.

21. The packaging article of claim 18, wherein the structural material is polyethylene, poly(ethylene/vinyl acetate), poly(ethylene/methyl acrylate), a metal foil, paperboard, cardboard, or a mixture of two or more thereof.

22. The packaging article of claim 18, wherein the third layer contains the functional absorber.

23. The packaging article of claim 1, further comprising a fourth layer, containing a gas barrier material, wherein the fourth layer is located between the first layer and the package exterior.

24. The packaging article of claim 23, wherein the gas barrier material is poly(ethylene vinyl alcohol) (EVOH), polyacrylonitrile, a copolymer comprising acrylonitrile, poly(vinylidene dichloride) (PVDC), polyethylene terephthalate (PET), polyethylene napthalate (PEN), a polyamide, a metal foil, or a mixture of two or more thereof.

25. The packaging article of claim 1, wherein the packaging article is a gable-top carton.

26. The packaging article of claim 1, containing a beverage or food in the package interior.

27. The packaging article of claim 26, wherein the beverage is a fruit or vegetable juice.

28. The packaging article of claim 26, wherein the beverage is orange juice.

29. The packaging article of claim 1, further comprising a structural layer comprising paperboard, wherein the structural layer is located between the first layer and the package exterior, wherein the packaging article is a gable-top carton and the packaging article contains orange juice in the package interior.

30. A method of packaging a food or a beverage, comprising:
sealing the food or the beverage in a packaging article defining a package interior and a package exterior, and comprising (i) a first layer, containing an oxygen scavenging polymer comprising (a) an ethylenic backbone or a polyester backbone and (b) at least one cyclic olefinic group; (ii) a second layer, containing a functional barrier polymer; and (iii) a transition metal organic salt in at least one of the first layer or a layer adjacent to the first layer; wherein the second layer is located between the first layer and the package interior.

31. The method of claim 30, wherein the packaging article further comprises a functional absorber.

32. The method of claim 30, wherein the functional barrier polymer is a polymer at least in part derived from a propylene monomer, a polymer derived at least in part from a vinyl acetate monomer, a polymer derived at least in part from a butyl acrylate monomer, a polymer derived at least in part from an acrylic acid or a methacrylic acid monomer, an ionomer derived from acrylic acid monomer or methacrylic acid monomer, polyethylene terephthalate glycol (PETG), amorphous nylon, or a mixture of two or more thereof.

33. The method of claim 30, wherein the packaging article further comprises a third layer, containing a structural material.

34. The method of claim 33, wherein the third layer is between the first layer and the package interior.

35. The method of claim 33, wherein the third layer is between the first layer and the package exterior.

36. The method of claim 33, wherein the structural material is polyethylene, poly(ethylene/vinyl acetate), poly(ethylene/methyl acrylate), a metal foil, paper, paperboard, cardboard, or a mixture of two or more thereof.

37. The method of claim 33, wherein the third layer contains the functional absorber.

38. The method of claim 30, wherein the packaging article further comprises a fourth layer, containing a gas barrier material, wherein the fourth layer is located between the first layer and the package exterior.

39. The method of claim 38, wherein the gas barrier material is poly(ethylene vinyl alcohol) (EVOH), polyacrylonitrile, a copolymer comprising acrylonitrile, poly(vinylidene dichloride) (PVDC), polyethylene terephthalate (PET), polyethylene napthalate (PEN), a polyamide, a metal foil, or a mixture of two or more thereof.

40. The method of claim 30, wherein the packaging article is a gable-top carton.

41. The method of claim 30, wherein the food or beverage is orange juice.
